(19) United States
(12) Patent Application Publication
(10) Pub. No.: US 2023/0271869 A1
(43) Pub. Date: Aug. 31, 2023

(54) MOLTEN GLASS TRANSPORT GUIDE FOR A TRANSPORT CUP

(71) Applicant: Owens-Brockway Glass Container Inc., Perrysburg, OH (US)

(72) Inventors: Stephen M. Graff, Maumee, OH (US); Karl Johnston, Perrysburg, OH (US)

(21) Appl. No.: 18/113,754

(22) Filed: Feb. 24, 2023

Related U.S. Application Data
(60) Provisional application No. 63/313,887, filed on Feb. 25, 2022.

(51) Int. Cl. C03B 7/14

(52) U.S. Cl. CPC C03B 7/14

(57) ABSTRACT

A transport guide, in the form of a conduit, for a molten glass transport cup is comprised of a glass contact material that supports the permeable flow of cooling gas from an outer surface to an inner surface of the conduit. When a molten glass charge is received in the conduit, the permeable flow of the cooling gas through the conduit fluidly displaces the glass charge radially inwardly away from the inner surface of the conduit to create a thermal break between the glass charge and the glass contact material. This thermal break helps minimize heat flow out of the molten glass charge. In this way, the molten glass charge can be received within the conduit of the transport cup, and in certain applications transported within the cup from one location to another location, while helping to preserve thermal homogeneity of the glass charge.

### TECHNICAL FIELD

This patent application discloses apparatuses and methods for glass container manufacturing and, more particularly, apparatuses and methods for transporting molten glass from a glass feeder to forming equipment.

### BACKGROUND

Glass container manufacturing processes typically include the following general process steps: (a) melting raw materials in a glass furnace or melter to produce molten glass; (b) producing a discrete portion or charge of the molten glass, such as a “gob,” by flowing a stream of the molten glass out of a glass feeder and cutting the stream with shears to produce the molten glass gob; (c) delivering the molten glass gob to a blank mold of a glass container forming machine that forms the molten glass gob into a “parison” or a partially-formed container; (d) opening the blank mold and transferring the parison to a blow mold of the glass container forming machine; and (e) blowing the parison against internal walls of the blow mold to form a glass container. In conventional processes, the molten glass gobs are delivered from the glass feeder to their respective blank molds by gob delivery equipment that includes a lengthy and widespread series of distributor funnels, scoops, troughs, and deflectors that rely on gravity to propel the gobs through the system.

Conventional gob delivery equipment is quite useful and dependable in many circumstances. But this standard equipment makes it difficult to precisely form glass containers with minimal weight since each of the glass gobs that travels through the interconnected system of funnels, scoops, troughs, and deflectors en route to the blank mold is cooled unevenly. More specifically, as the glass gob travels along the lubricated delivery equipment, the longitudinal surface portion of the gob that is in sliding contact with the delivery system components loses heat to the delivery system components and, as a result, becomes colder than the rest of the surface of the gob. As such, the glass gob typically exhibits an inhomogeneous temperature profile around its circumference when it is delivered to the blank mold and may also have a varying shape due to being non-uniformly elongated along the delivery system components. For these reasons, the molten glass gob usually deforms and flows irregularly within the blank mold when being formed into a parison, which can lead to glass containers having an inconsistent wall thickness. The amount of glass included in each molten glass gob is engineered to account for this wall thickness disparity; that is, extra glass is included in the glass gob so the even the thinnest portion of the glass container wall will meet or exceed a minimum threshold thickness, even though other portions of the container wall may be much thicker than necessary.

The present disclosure describes a transporter that is used to transport a molten glass charge, for example, from the glass feeder to a glass container forming machine. The transporter, and in particular, the portion of the transporter that immediately surrounds the molten glass charge, is constructed to help deliver the molten glass charge to the forming machine with improved thermal homogeneity. The use of the transporter to transport the molten glass charge allows much, if not all, of the conventional gob delivery equipment to be eliminated, and its delivery of a more thermally homogeneous molten glass charge to the blank mold helps produce a glass container with a more consistent wall thickness. A more consistent container wall thickness, in turn, enables more of the glass container wall to be formed at a thickness closer to the minimum threshold thickness. This provides an opportunity to minimize excess glass weight within the glass container. For instance, a significant portion of the additional glass that is usually included in a glass container formed from glass delivered to a blank mold by conventional gob delivery equipment may be eliminated from a glass container formed from glass delivered by the transporter.

### SUMMARY OF THE DISCLOSURE

In one implementation of the present disclosure, a molten glass transport cup includes a conduit defining an inlet, an outlet, and a passage between the inlet and the outlet. The conduit is comprised of a glass transport material having a permeability between 1 md and 250 md and a thermal conductivity that is greater than or equal to 40 W/m-°K over the temperature range of 300° C.-400° C. In another implementation of the present disclosure, a molten glass transport cup includes a conduit defining an inlet, an outlet, and a passage between the inlet and the outlet. Here, the conduit is comprised of a glass transport material and exhibits a permeable air flow rate of at least 100 g/s/m² at a pressure differential across the glass transport material of 30 psig or less. The glass transport material further has a thermal conductivity that is greater than or equal to 40 W/m-°K over the temperature range of 300° C.-400° C.

In still another implementation of the present disclosure, a method of handling a molten glass charge includes receiving a molten glass charge in a holding cavity of a molten glass transport cup. The holding cavity is provided by a conduit, which defines a passage extending between an inlet and an outlet of the conduit, and an endcap moveable to cover and uncover the outlet of the conduit. The method also includes suppling a cooling gas to an outer surface of the conduit such that the cooling gas diffuses permeably through the conduit and displaces the molten glass charge radially inwardly away from an inner surface of the conduit to create a thermal break between the molten glass charge and the conduit.

In yet another implementation of the present disclosure, a method of transporting a molten glass charge includes providing a transporter that includes a transport cup having a conduit. The conduit has an inner surface that defines a passage extending from an inlet of the conduit to an outlet of the conduit. The conduit additionally exhibits a permeable air flow rate of at least 100 g/s/m² at a pressure differential across the conduit of 30 psig or less. The method further includes closing the conduit by positioning an endcap below the outlet of the conduit to cover and block the outlet and to thereby provide a holding cavity, and receiving a charge of molten glass in the holding cavity through the inlet of the conduit at a loading location. Still further, the method includes suppling a cooling gas to an outer surface of the conduit such that the cooling gas diffuses permeably through the conduit and displaces the molten glass charge radially inwardly away from the inner surface of the conduit to create a thermal break between the molten glass charge and the inner surface of the conduit. The method additionally includes transporting the transporter from the loading location to an unloading location and then opening the conduit by moving the endcap away from the outlet of the conduit such that the molten glass charge is discharged from the outlet of the conduit.

### BRIEF DESCRIPTION OF THE DRAWINGS

FIG. 1 is an upper perspective view of a molten glass transporter in accordance with an illustrative embodiment of the present disclosure, illustrating a transport cup that includes a transport guide at least partially made of a glass transport material;

FIG. 2 is a cross-sectional perspective view of the transport cup of the molten glass transporter depicted in FIG. 1;

FIG. 3 is a cross-sectional view of a conduit of the transport cup depicted in FIGS. 1 and 2 when a molten glass charge is initially received in the conduit, and further showing an enlarged schematic representation of the inner surface of the conduit;

FIG. 4 is a cross-sectional view of the conduit of the transport cup depicted in FIGS. 1 and 2 after the molten glass charge is received in the conduit, and further showing an enlarged schematic representation of the inner surface of the conduit;

FIG. 5 is a table showing various material properties of possible glass transport materials for use with the transport guide illustrated in FIGS. 1-4; and

FIG. 6 is schematic illustration of a general method for transporting a charge of molten glass in the transporter from one location, e.g., from a loading station beneath a glass feeder, to another location, e.g., to a discharge station above a glass container forming machine.

### DETAILED DESCRIPTION

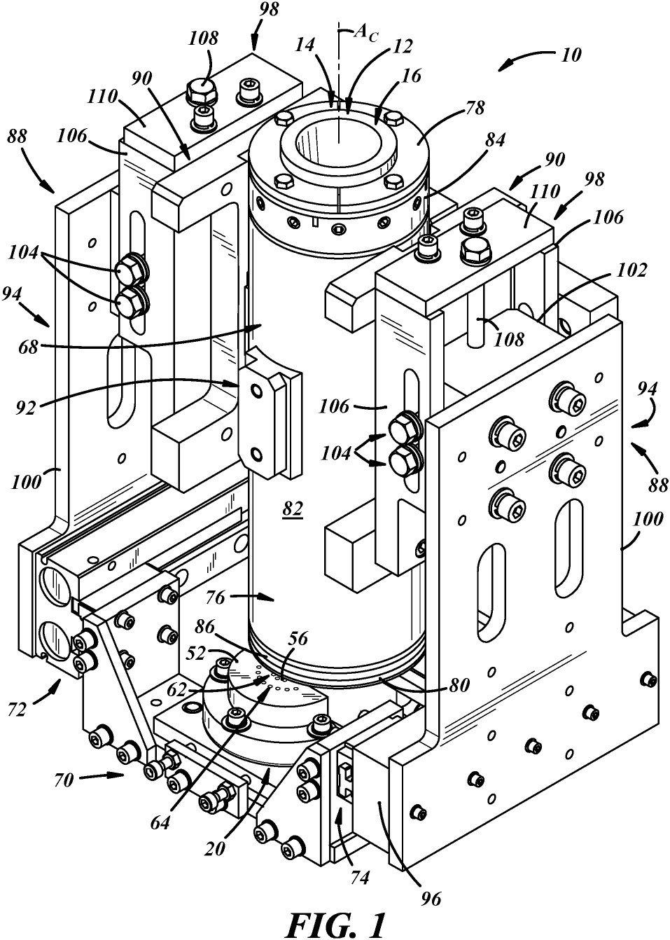

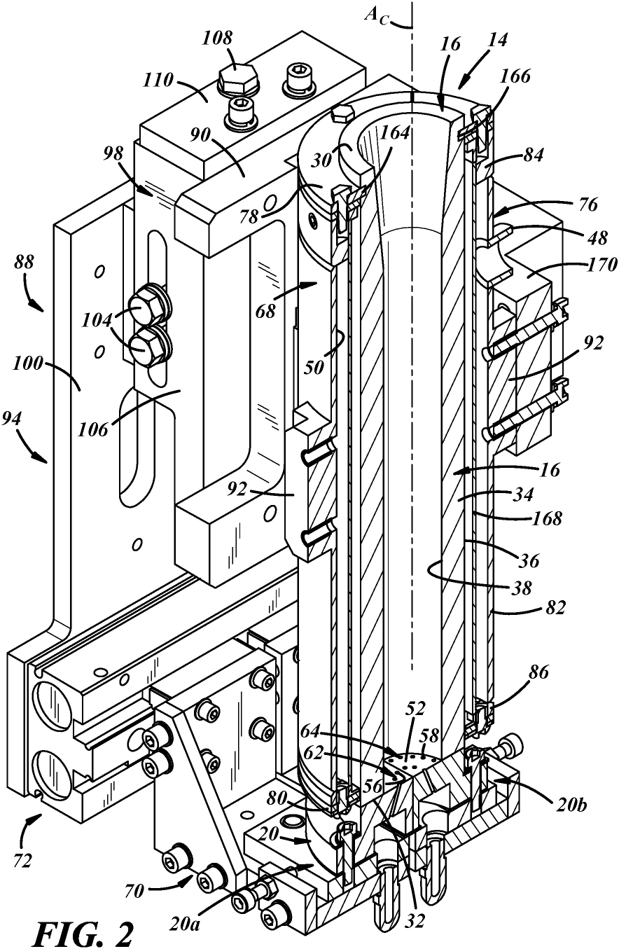

The present disclosure is directed to several embodiments of a transport guide for use in a molten glass transporter that transports a molten glass charge G from one location, e.g., from beneath a glass feeder, to another location, e.g., to above a blank mold of a glass container forming machine, and then releases the charge G. FIGS. 1-2 depict a transporter 10 that includes a transport guide 12 as part of a transport cup 14 in accordance with one embodiment of the disclosure. The transport guide 16 may be in the form of a conduit 16 (shown best in FIGS. 2-4) having an outer surface 36, which is exposed to a cooling gas within a cooling chamber 50, and an inner surface 38 that defines a passage 28. The transport cup 14 supports the molten glass charge G within the passage 28 of the conduit 16; however, the charge G is not permitted to indiscriminately flow within the conduit 16 to fill and match the volume of the passage 28 it occupies and to press into the inner surface 38. Rather, prolonged direct contact between the molten glass charge G and the inner surface 38 of the conduit 16 is avoided by fluidly displacing the charge G radially inwardly around the circumference of the charge G to resist glass flow towards the inner surface 38, although the charge G may occasionally make contact with the inner surface 38 when being loaded into the conduit 16, when being unloaded from the conduit 16, or intermittently when being held within the conduit 16.

The conduit 16 of the transport cup 14 is comprised of glass transport material, and apart from generally being able to handle glass and operate at elevated temperatures, the material properties of the glass transport material directly affect the performance of the conduit 16 in terms of influencing the molten glass charge G away from the inner surface 38 in order to inhibit heat flow out of the charge G. The selection of the glass transport material based on gas permeability in particular, with thermal conductivity also being relevant, can result in the conduit 16 being better able to hold the molten glass charge G away from the inner surface 38 and to control the positioning of the charge G during loading and unloading. In that regard, a correlation exists between the identified material property or properties of the glass transport material, as discussed below, and the ability of the conduit 16, in operation, to minimize heat loss from the molten glass charge G and help preserve the initial heat content of the glass. This heat preservation capability of the glass transport material, in turn, minimizes the formation of temperature variances within and on the surface of the molten glass charge G during transport, particularly the formation of circumferential surface temperature variations around the charge G.

The design and development of the transport guide 12 and the glass transport material from which the guide 12 (e.g., the conduit 16 being one implementation of the guide 12) is formed originally focused on a confluence of factors. For example, when receiving and transporting the molten glass charge G within the transport cup 14, controlled thermal regulation between the inner surface 38 of the conduit 16 and the glass charge G proved to be a challenge. Excessive and prolonged contact between the inner surface 38 of the conduit 16 and the molten glass charge G may cause surface temperature variations to develop axially along and circumferentially around the surface of the glass charge G, thus imparting thermal inhomogeneity into the glass charge G, and may also increase the likelihood that the glass charge G sticks to the inner surface 38 of the conduit 16. The material selection for the glass transport material that provides the inner surface 38 of the conduit 16 of the transport cup 14 therefore acquired added significance during development of the conduit 16 and the overall cup 14.

Early in the development of the transport cup 14, it was assumed that the main material property to consider when designing and selecting the glass transport material for the conduit 16 was the operating temperature of the glass transport material. This assumption led to the belief that identifying a glass transport material that could operate as close to the expected temperature of the glass charge (~1200° C.) would be of prime importance so that heat transfer between the glass charge G and the inner surface 38 of the conduit 16 would be minimized as much as possible. But the problem of glass sticking was difficult to avoid with materials that could operate at higher operating temperatures approaching the temperature of the glass charge G. As it turns out, the temperature at which glass stuck to the glass transport material of the conduit 16 was not as dependent on the chemical or physical properties of the glass transport material but, rather, was driven by the viscosity of the glass, which, if allowed to contact and conform to the inner surface 38 of the conduit 16, will penetrate into the porosity of all known materials above a certain temperature. In other words, as the temperature of the glass transport material of the conduit 16 increased, the molten glass charge G was more likely to stick to the inner surface 38 of the conduit 16. In fact, a material temperature of approximately 625° C. and above seems to produce glass sticking independent of the material chosen as the glass transport material.

It was eventually recognized that the diffusion of cooling gas—which is passed exteriorly around the conduit 16 to regulate the temperature of the conduit 16—through the intrinsic microstructure of glass transport material that forms the conduit 16 and into the passage 28 had an effect on the skin temperature of molten glass charge G. The diffusing cooling gas, if flowing through the glass transport material at a fast enough rate, appeared to counter the natural tendency of the molten glass charge G to conform to the inner surface 38 of the conduit 16 by fluidly displacing the charge G circumferentially inwardly away from the inner surface 38. This pushing action of the diffusing cooling gas is believed to beneficially impact the operability of the conduit 16 in a multitude of ways. First, the diffusing cooling gas helps to self-center the molten glass charge G and minimize frictional contact between the charge G and the inner surface 38 of the conduit 16 as the charge G falls into passage 28 during loading, which decreases the sensitivity of the process to variation in gob position and shape when loading the glass charge G into the conduit. Second, the diffusing cooling gas forms a thermal break between the molten glass charge G and the inner surface 38 of the conduit 16 after the charge G has been received in the passage 28. The thermal break disrupts heat flow from the glass charge G into the surrounding glass transport material of the conduit 16, thus helping thermally insulate the gob G from heat loss around the entire length and circumference of the gob G. Additionally, when the molten glass gob G is stationary within the passage 28, the diffusing cooling gas may occupy the surface roughness of the inner surface 38 and press the charge G circumferentially inwardly away from the porosity of the inner surface 38 to such an extent that the charge G is physically separated from the inner surface 38 of the conduit 16 by a gas barrier. Third, the diffusing cooling gas helps minimize friction with the inner surface 38 of the conduit when the charge G is dropped from passage 28 during unloading of the charge G, which reduces wear on the glass transport material.

The capacity of the glass transport material of the conduit 16 to support the diffusive flow of the cooling gas can be quantified by determining the permeable flow rate of air through the conduit 16. Since diffusive flow refers to gas flow through the interconnected porosity of the microstructure of the glass transport material, as opposed to through holes or other apertures formed directly through the material, the permeable air flow rate is a measurement of how much air passes through the microstructure of the glass transport material over a given period of time per unit of surface area of the inner surface 38 at a given pressure differential across the material. The higher the permeable air flow rate, the more air that flows diffusively through the glass transport material of the conduit 16, and vice versa. And just because air is the medium used to determine the permeable flow through the glass transport material of the conduit 16 as an indication of how a material supports diffusive flow does not mean that the cooling gas used to regulate the temperature of the conduit 16 must also be air; rather, any suitable cooling gas may be used.

When used in the application of the conduit 16 as part of the transport cup 14, it was determined that a glass transport material exhibiting a permeable air flow rate of at least 100 g/s/m², or more preferably at least 150 g/s/m², at a pressure differential across the material of 30 psig or less, possessed sufficient diffusive flow that good, repeatable performance in terms of mitigating heat loss from the molten glass charge G and glass sticking within the conduit 16 could be achieved. The permeable air flow rate through a given glass transport material when constructed as the conduit 16 can be determined by measuring the permeability of the glass transport material, k, as specified in the ASTM D4525-13 Standard, as indicated below. For a conduit 16 comprised of a glass transport material of a given thickness and with a given pressure differential across the conduit 16, the permeability can be used to calculate the permeable air flow rate through the glass transport material of the conduit 16.

By constructing the conduit 16 to achieve the permeable air flow rate described above, the diffusive flow of cooling gas through the conduit 16 and into the passage 28 through the inner surface 38 of the conduit 16 can be adjusted in coordination with various phases of the operation of the transporter 10 by controlling the pressure of the cooling gas within the cooling chamber 50. For example, when the cooling gas used is air, the permeable flow rate of the cooling gas through the conduit 16 may be controlled as follows: (1) during a loading phase when the molten glass charge G is received into the passage 28 of the conduit 16, the permeable flow rate is set to a loading range of 20 g/s/m² to 150 g/s/m² to narrow or squeeze the charge G circumferentially inwardly and help self-center the charge G as the charge G falls into the passage 28; (2) during a transport phase when the molten glass charge G is received in the passage 28 and being moved by the transporter 10, the permeable flow rate is set to a transport range of 20 g/s/m² to 150 g/s/m² to attain minimal heat transfer rate from the molten glass charge G to the surrounding conduit 16; and (3) during an unloading phase when the molten glass charge G is dropped from the conduit 16, the permeable flow rate of the cooling gas is set to an unloading range of 0.03 g/s/m² to 20 g/s/m², or more preferably between 4 g/s/m² to 20 g/s/m², to allow the charge G to relax circumferentially outwardly so that the charge G can be more precisely and accurately dropped out of the conduit 16. Additionally, during a return phase after the molten glass charge G has been unloaded but prior to loading of the next charge, the cooling gas flow around the conduit 16 within the cooling chamber 50 is adjusted to extract excess heat from the previous glass charge G away from the conduit 16 to help maintain the temperature of the glass transport material of the conduit 16 a target operating temperature (e.g., 100° C. to 400° C.) within acceptable tolerances. The adjustment of the cooling gas flow rate within the cooling chamber 50 may affect the permeable flow rate of the cooling gas through the conduit 16, although such variances in the permeable flow rate during the return phase are not believed to affect the functionality of the conduit 16.

The permeable flow rate through the glass transport material of the conduit 16 is dictated primarily by (i) the pressure differential across the glass transport material, which, in the transporter 10, is attained by controlling the cooling gas pressure in the cooling chamber 50 that surrounds the conduit 16, (ii) the thickness of the glass transport material, and (ii) various material properties of the glass transport material including the porosity of its microstructure, the average particle size and particle size distribution of the material, the interconnectedness of the internal voids through the microstructure of the material, and the manner in which the material is manufactured, all of which can collectively represented by the permeability of the material. To achieve the desired permeable air flow rate, which indicates sufficient diffusive flow of the cooling gas is possible through the conduit 16, particularly at cooling gas pressures within the cooling chamber 50 that may range from 1 psig to 100 psig, the glass transport material used to construct the conduit 16 preferably has a permeability (k) ranging from 1 millidarcy (md) to 250 md or, more narrowly, from 10 md to 150 md or from 50 md to 135 md, when measured according to the ASTM D4525-13 Standard. The term “permeability” as used herein is a proportionality constant and is often used synonymously with the term “coefficient of permeability,” as in the ASTM D4525-13 Standard, or the “permeability coefficient.”

Additionally, and secondarily to permeability, the thermal conductivity of the glass transport material is another material property of the glass transport material that is believed to be relevant. Indeed, quite counterintuitively, it is believed that a higher thermal conductivity nominally supports forming the thermal break between the molten glass charge G and the inner surface 38 of the conduit, rather than a lower thermal conductivity, and also helps minimize the propensity for glass to stick to the inner surface 38 by abating localized hot spots along the inner surface 38. Specifically, when the thermal conductivity of the glass transport material is greater than or equal to 40 W/m-°K or, more specifically, greater than or equal to 60 W/m-°K, over the temperature range of 300° C.-400° C., the glass transport material can better resist glass adhesion at the operating temperature of the conduit 16. In certain embodiments, the thermal conductivity of the glass transport material is preferably between 100 W/m-°K and 200 W/m-°K, inclusive, or more narrowly between 130 W/m-°K and 180 W/m-°K, inclusive, over the same temperature range (i.e., 300° C.-400° C.) just mentioned. Since the thermal conductivity of a material typically decreases with increasing temperature, which is the case for carbon-based materials including graphite-based materials, the thermal conductivity of a potential glass contact material may be ascertained at 400° C. to determine whether the material satisfies the thermal conductivity constraints listed above.

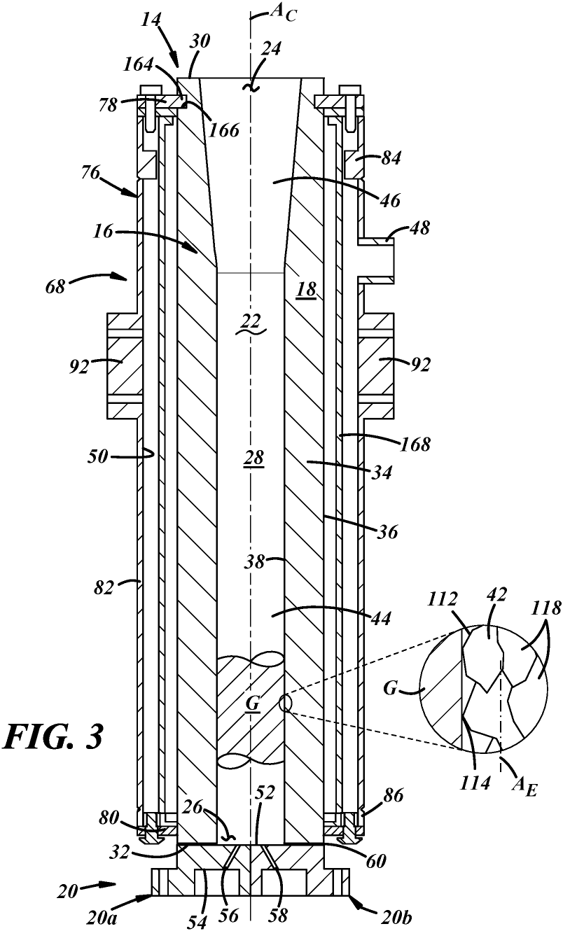

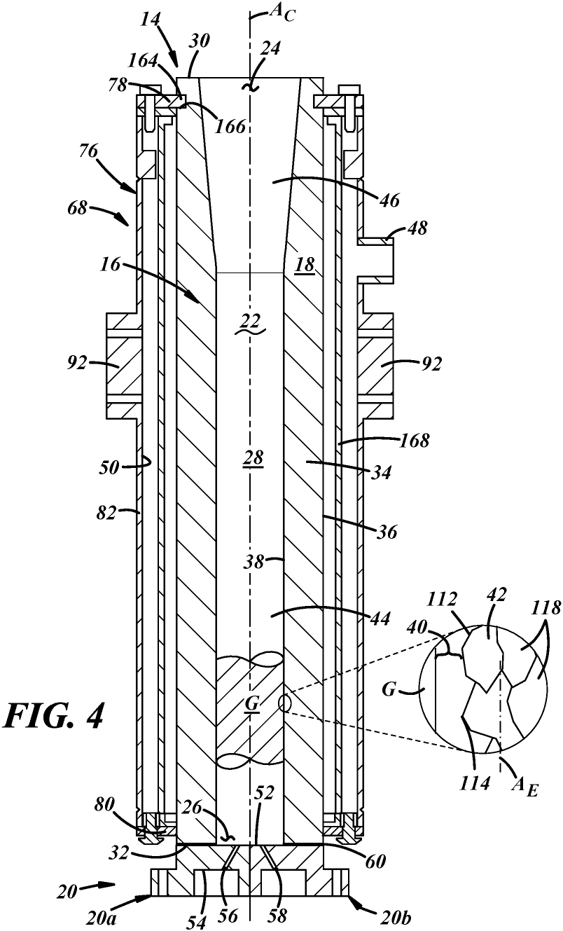

Turning now to FIGS. 1-4, an example embodiment of the transporter 10 that includes the conduit 16 as part of the transport cup 14 is illustrated. The transporter 10 is used to transport a discrete portion or charge of molten glass, referred to herein as the molten glass charge G (FIGS. 3-4), from a glass feeder (not shown) to, for example, one or more blank molds (not shown) located in any suitable location relative to the glass feeder, including at elevations above, below, or level with the feeder. Although not illustrated, the glass feeder may, as is known in the art, include one or more feeder orifices that dispense molten glass streams and one or more shears, lasers, or the like that separate the molten glass streams into the discrete charges G of molten glass. The transporter 10 may be translated, rotated, pivoted, swung, articulated, and/or moved in any other manner suitable for transporting a molten glass charge between its loading and unloading destinations. In one particular implementation, the transporter 10 is translated along a linear path back-and-forth between the loading and unloading destinations without being inverted. Additionally, and although not illustrated, a robot, a gantry, rodless cylinder, or any other suitable transporter mover may be used to move the transporter 10 between its loading and unloading destinations.

The transporter 10 includes the transport cup 14, which, in turn, includes the conduit 16 to receive the molten glass charge G, as shown more specifically in FIGS. 3-4. The conduit 16 is constructed from the glass transport material, which is designated by reference numeral 18 and has been introduced in the discussion above. The glass transport material 18 is particularly useful in cup-based applications for the transport guide 12, such as the conduit 16, which has a circumferentially continuous surface area that surrounds the molten glass charge G when the charged G is received in the conduit 16. In this way, the molten glass charge G can be displaced by permeable cooling gas flow radially inwardly away from the inner surface 38 of the conduit 16 around its entire circumference in order to avoid, as much as possible, uneven thermal treatment of the charge G.

With reference to FIGS. 2-4, the conduit 16 defines an inlet 24 and an outlet 26, and further defines the passage 28, which extends between the inlet 24 and the outlet 26 along a conduit passage axis Ac. The conduit passage axis A_{C} may extend vertically. As used herein, the term “vertically” does not necessarily mean perfectly or absolutely parallel to gravity (i.e., absolute vertical) but encompasses angular deviations of ± 2 degrees from absolute vertical. The conduit 16 includes an inlet end surface 30 defining the inlet 24, an outlet end surface 32 defining the outlet 26, and a sidewall 34 that extends between the inlet and outlet end surfaces 30, 32 and circumferentially around the conduit passage axis Ac. The sidewall 34 includes the outer surface 36 and the inner surface 38, which define a thickness of the conduit 16. And, as discussed above, the inner surface 38 defines the passage 28 and is the surface of the conduit 16 that circumferentially surrounds the molten glass charge G and through which cooling gas flows permeably into the passage 28 to create the thermal break around the charge G. The inlet 24 and outlet 26 may be coaxial with, and lie in a plane perpendicular to, the conduit passage axis Ac, as shown in the illustrated embodiment.

The passage 28 defined by the conduit 16 includes a lower portion 44 and an upper portion 46. The lower portion 44 may be cylindrical and have a constant diameter or cross-sectional flow area measured perpendicular to the conduit passage axis Ac, and the upper portion 46 may be tapered to have a variable diameter or cross-sectional flow area that narrows along the conduit passage axis A_{C} from the inlet 24 towards the outlet 26. The tapering of the upper portion 46 serves as a funnel to, if needed, help guide a falling molten glass charge G from the inlet 24 down into the lower portion 44 of the passage 28. Of course, the upper portion 46, if tapered, would provide the inlet 24 with a larger cross-sectional flow area than that of the outlet 26. The conduit sidewall 34 may be of circular cylindrical shape along its outer surface 36, as illustrated, or may be of ovular cylindrical shape, or of any other shape suitable for receiving, carrying, and transporting the molten glass charge G. The conduit 16 may be a unitary piece, as shown, or assembled in multiple parts.

The outlet end surface 32 of the conduit 16 may be perpendicular to the conduit passage axis A_{C} and, accordingly, the outlet end surface 32 may a flat surface that extends radially inwardly on a plane perpendicular to the conduit passage axis A_{C} from the outer surface 36 of the conduit sidewall 34 to the inner surface 38. While the outlet end surface 32 may be a flat surface, as illustrated, the outlet end surface 32 may also be crowned or slightly rounded in other embodiments. The inlet end surface 30 of the conduit 16 may be perpendicular to the conduit passage axis A_{C} in a similar fashion to the outlet end surface 32 as shown, but does not necessarily have to be. As used herein, the term “perpendicular” does not necessarily mean perfectly or absolutely perpendicular to the conduit passage axis A_{C} but encompasses deviations of ± 2 degrees from absolute perpendicular.

The transport cup 14 additionally includes an endcap 20 that is movable with respect to the conduit 16 to selectively open and close the conduit 16. To close the conduit 16, the endcap 20 is moved toward and underneath the conduit 16 and is located closely adjacent to the conduit 16— this position of the endcap 20 being the closed or transport position. In this position, the endcap 20 covers or blocks the outlet 26 of the conduit 16 to axially close the passage 28 of the conduit 16 and create a holding cavity 22 where the molten glass charge G may be received through the inlet 24 and retained. To open the conduit 16, the endcap 20 is moved away from the conduit 16— this position of the endcap 20 being the open or dispensing position—such that the endcap 20 is spaced from and does not block or cover the outlet 26 of the conduit 16, meaning that the holding cavity 22 is no longer established and the passage 28 is once again axially unobstructed at the outlet 26. In this way, when the molten glass charge G is received in the holding cavity 22, the molten glass charge G can be carried by the transporter 10 to a different location, such as above a blank mold of a glass container forming machine, and the endcap 20 can be used to selectively open the conduit 16 to permit the molten glass charge to fall through and exit the conduit 16. The discharged molten glass charge G would then be received in the blank mold for forming.

The conduit 16 is constructed from the glass transport material 18, as discussed above, and the endcap 20 may optionally be constructed from the same glass transport material 18 or some other material. In a preferred embodiment, both the conduit 16 and the endcap 20 are wholly constructed of the glass transport material 18. The glass transport material 18 embodies certain material properties that permit the molten glass charge G to be displaced away from the inner surface 38 of the conduit 16 to retain heat within the charge G while also minimizing the occurrence of localized hot spots. This is best demonstrated with reference to FIGS. 3-4. In FIG. 3, when the molten glass charge G is initially received in the holding cavity 22, which is partially defined by the passage 28, the exterior surface of the glass charge G may initially contact the inner surface 38 of the conduit 16, but in some cases the glass charge G may not contact the inner surface 38 depending on various factors including, for instance, the size the glass charge G, the speed of the glass charge G upon loading, and the rate of permeable flow of the cooling gas through the conduit 16. More specifically, the charge G may contact the inner surface 38 of the conduit 16 over at least a portion of the length and circumference of the charge G, with circumferentially continuous contact between the glass charge G and the inner surface 38 along the entire length of the charge G being possible in some instances. After a short period of contact, however, and as shown in FIG. 4, the molten glass charge G is displaced away from the inner surface 38 of the conduit 16 around its entire length and circumference by cooling gas flowing permeably through the conduit 16 from the cooling chamber 50. This pressure on the molten glass charge G creates a thermal break in the form of gas barrier 40 that separates the glass charge G from the glass transport material 18. In FIGS. 3-4, the schematic illustration of the thermal break and a microstructure 42 of the inner surface 38 provided by the glass transport material 18 is not drawn to scale.

The endcap 20 may be constructed in numerous ways. In the embodiment shown here in FIGS. 1-4, for example, the endcap 20 includes two cooperating endcap halves 20a, 20b that slide towards and away from each other transverse to the conduit passage axis A_{C} to selectively close and open the conduit 16, respectively. The endcap halves 20a, 20b, when brought together to close the conduit 16, provide a central end surface 52 that faces the outlet end surface 32 of the conduit 16, as well as the outlet 26 of the passage 28, and a terminal end surface 54 that is axially opposite the central end surface 52. One or more fluid supply passages may be defined in the endcap 20 and, in this particular embodiment, one or more fluid supply passages 56 may be defined in one of the endcap halves 20a and one or more fluid supply passages 58 may be defined in the other endcap halve 20b. The fluid supply passages 56, 58 are open at the central end surface 52 so that a fluid, which is separately controlled from the cooling gas that flows permeably through the conduit 16, can be supplied into the holding cavity 22. Moreover, when the endcap cover 20 is positioned in the closed or transport position to block the outlet 26 of the conduit 16, the endcap 20 may be axially spaced from the conduit 16 to provide an exhaust gap 60 between the outlet end surface 32 of the conduit 16 and the central end surface 52 of the endcap 20. This gap 60 provides a fluid flow path from the passage 28 of the conduit 16 to the external environment outside of the conduit 16 when the conduit 16 is closed by the endcap 20 and, thus, functions as a fluid exhaust outlet. One or both of the end surfaces 52, 54 of the endcap 20 may comprise straight surfaces as shown, or may include crowned or slightly rounded surfaces.

As shown in FIGS. 3-4, the molten glass charge G may be held above the central end surface 52 of the endcap 20 when received in the holding cavity 22 (that is, the passage 28 of the conduit 16 when the conduit 16 is closed). More specifically, the charge G may be levitated above the central end surface 52 of the endcap 20 over the entire diameter of the charge G by a fluid cushion. To displace the charge G away from the central end surface 52 of the endcap 20, the fluid supply passages 56, 58, which extend between the central end surface 52 and the terminal end surface 54 of their respective endcap halves 20a, 20b, may be arranged as illustrated in a first circular array 62 and a second circular array 64 outside of the first circular array, as shown in FIG. 1. In other embodiments, the fluid supply passage(s) 56, 58 may be arranged in one or more ovular arrays, linear arrays, rectangular arrays, or any other arrangement suitable to displace the molten glass charge G away from the central end surface 52 of the endcap 20. The pluralities of fluid supply passages 56, 58 may extend through the endcap 20 at one or more oblique angles with respect to the conduit passage axis Ac. For example, as shown in FIGS. 3 and 4, the fluid supply passages 56, 58 can be oriented to converge with respect to the conduit passage axis Ac, although it is also possible to have the fluid supply passages 56, 58 diverge with respect to the conduit passage axis A_{C} or have some fluid supply passages 56, 58 that converge and others that diverge. In yet other embodiments, one or more of the fluid supply passages 56, 58 may extend through the endcap 20 parallel to the axis Ac.

The size, quantity, orientation, and/or configuration of the fluid supply passages 56, 58 may vary depending on the desired specifications of the glass making system. These variations may be enhanced by the machinability of the glass transport material 18, as a more machinable material 18 may allow for more precisely and/or more intricately formed fluid supply passageways 56, 58. Additionally, the type, flow rate, pressure, and other characteristics of the fluid supplied through the fluid supply passages 56, 58 may be chosen so as to ensure that the fluid supplied into the holding cavity 22 when the conduit 16 is closed by the endcap 20 is sufficient to displace the molten glass charge G away from the central end surface 52 of the endcap 20 but does not eject the glass charge G out of the conduit 16 back through the inlet 24. For instance, fluid may flow into the holding cavity 22 through the fluid supply passages 56, 58 at a total flow rate (i.e., combined flows through all of the passages 56, 58) that ranges from 30 standard liters per minute (slpm) to 350 slpm or, more narrowly, from 60 slpm to 300 slpm. In a particular example, and within the aforementioned ranges, the fluid may be supplied through the fluid supply passages 56, 58 at a first flow rate as the molten glass charge G is loaded into the conduit 16 and moving towards the outlet 26. The fluid may then be supplied through the fluid supply passages 56, 58 at a second flow rate lower than the first flow rate after the charge G is loaded into the conduit 16 and is no longer moving towards the outlet 26. The first higher fluid flow rate may prevent the molten glass charge G from impacting the endcap 20 during loading of the glass charge G into the conduit 16 of the transport cup 14, or at least slow the velocity at which the molten glass charge G is falling, and the second lower fluid flow rate may maintain the fluid cushion under the glass charge G.

The fluid supplied through the fluid supply passage(s) 56, 58 may be a pressurized gas including, for example, air, oxygen, nitrogen, or any other gas suitable for contact with molten glass. Although not illustrated, the pressurized gas may be provided from a vessel pressurized with the gas, a gas line pressurized by a pump, or any other suitable source of pressurized gas, and a flow rate of the pressurized gas may be controlled by one or more proportional valves or in any other suitable matter. Without fluid supplied through the fluid supply passage(s) 56, 58 of the endcap 20, the molten glass charge G would engage the central end surface 52 of the endcap 20 at full speed and momentum upon being received into the conduit 16 and would lose significant heat to the endcap 20 as a result of the impact. The molten glass charge G would also engage a junction between the endcap 20 and the conduit 16 and/or a junction between the endcap halves 20a, 20b, which could form one or more parting lines in the molten glass charge G that might ultimately carry through to a glass article, especially a glass container, subsequently formed from the glass charge G.

The flow of fluid into the holding cavity 22 through the fluid supply passage(s) 56, 58 helps preserve the integrity of the molten glass charge G received in the conduit 16 in conjunction with thermal break created circumferentially around the glass charge G. The continuous flow of the fluid into the holding cavity 22 slows down the molten glass charge G as it enters the conduit 16 so that the charge G either engages the central end surface 52 of the endcap 20 with less than full force, and is then displaced away from the central end surface 52, or is kept from engaging the central end surface 52 in the first place. Also, after the molten glass charge G is received within the conduit 16, the fluid is supplied into the holding cavity 22 to levitate the molten glass charge away from the central end surface 52 of the endcap 20 and create the fluid cushion that occupies a space between the central end surface 52 and a lower end of the molten glass charge G. A stable fluid cushion is maintained with the aid of the exhaust gap 60, which provides a pressure relief vent that keeps the supplied pressurized fluid from building up enough pressure that the molten glass charge G is ejected out of the conduit 16 while also keeping the fluid from disruptively flowing through the thermal break alongside the glass charge G. Since the molten glass charge G is not in continuous contact with the central end surface 52 of the endcap 20, the formation of cold spots, particularly at the lower axial end of the glass gob G, and parting lines is mitigated or avoided. In that regard, the carry-through of the cold spots and/or parting lines to a finished glass container formed from the molten glass charge G can also be mitigated or avoided.

Returning now to FIG. 1, the transporter 10 may also include a conduit carrier 68 that holds the conduit 16, an endcap carrier 70 on which the endcap 20 is carried, an endcap actuator 72, and an endcap guide 74 coupled to the endcap carrier 70. The conduit carrier 68 may include an outer sleeve 76 that surrounds and is radially spaced from the conduit 16. The conduit carrier 68 also may include upper and lower mounting rings 78, 80 that are coupled to the outer sleeve 76 and engaged to corresponding portions of the conduit 16. The outer sleeve 76 may include a tubular body 82 and upper and lower caps 84, 86 that may be fastened, welded, threaded, or otherwise coupled to corresponding ends of the tubular body 82 to establish the cooling chamber 50 between the outer sleeve 76 and the conduit 16 where the cooling gas may flow. The cooling chamber 50 may be supplied with the cooling gas through a cooling gas inlet 48 defined in the tubular body 82 of the outer sleeve 76. And, while not shown here, the cooling gas inlet 48 is in fluid communication with a cooling gas supply. The cooling gas supplied to the cooling chamber 50 is preferably air, but other gases may be used as the cooling gas including, for example, oxygen, nitrogen, or any other gas suitable for contact with molten glass, and the pressure of the cooling gas in the cooling chamber 50 preferably ranges from 1 psig to 100 psig.

The upper mounting ring 78 may be fastened, welded, threaded, or otherwise coupled to the upper cap 84 of the outer sleeve 76 and may have one or more radially inwardly extending tongues 164 that fit into one or more corresponding grooves 166 in the conduit 16. To facilitate assembly of such a tongue-and-groove connection, the upper mounting ring 78 may be split, and constituted from semi-circumferential halves. The lower mounting ring 80 and mounting arrangement to the conduit 16 may be similar to that of the upper mounting ring 78. When the conduit carrier 68 is assembled around the conduit 16, the cooling chamber 50 established between the outer sleeve 76 and the conduit 16 is exposed to and covers at least 85%, or more preferably at least 90% or even at least 95%, of the outer surface 36 of the conduit 16. This ensures that a sufficient portion of the outer surface 36 of the conduit 16 is accessible to pressurized cooling gas in the cooling chamber 50 to support the diffusive flow of cooling glass through the conduit 16 and into the passage 28 for the reasons described herein.

The conduit carrier 68 also may include a baffle 168 located radially between the outer sleeve 76 and the conduit 16 to direct cooling gas supplied through the conduit carrier 68 to the conduit 16. The baffle 168 may establish a circuitous path for the flow of cooling gas within the cooling chamber 50. More specifically, in one possible implementation, the cooling gas enters the cooling chamber 50 through the cooling gas inlet 48 defined in the tubular body 82 of the outer sleeve 76, flows circumferentially around the baffle 168 and down to a lower end of the baffle 168 proximate the end cap 20 that may have gas passages (not shown) in the form of holes, reliefs, or axially-extending gaps. The cooling gas flows through the gas passages or around the lower end of the baffle 168, radially inwardly toward the conduit 16, and circumferentially around the conduit 16 between the conduit 16 and the baffle 168 and up and out of the cooling chamber 50 through one or more cooling gas outlets (not shown). The baffle 168 promotes more uniform impingement of the cooling gas circumferentially over the entire outer surface 36 of the conduit 104 and allows for the pressure differential across the conduit 16 between the outer surface 36 and the inner surface 38 to be more uniform, thus helping produce more uniform permeable cooling gas flow through the conduit 16 along the length of the conduit 16. Portions of the baffle 168 may be welded, fastened, interference fit, or otherwise coupled to corresponding portions of the outer sleeve 76.

The endcap actuator 72 is activatable to move and guide the endcap 20 to open and close the conduit 16 in the manner described above. The endcap actuator 72 may be or may include a linear rodless cylinder and may be pneumatic or hydraulic, or may include an electric device such as a linear motor, a rotary motor with a drive screw, a solenoid, or any other arrangement suitable to cause linear movement. To open the conduit 16, the endcap actuator 72 may be activated to split the endcap 20 and linearly displace the endcap halves 20a, 20b laterally along the endcap guide 74 and out of the way of the outlet 26 of the conduit 16. Conversely, to close the conduit 16, the endcap actuator 72 may be activated in reverse to linearly displace the endcap halves 20a, 20b of the endcap 20 laterally back toward each other along the endcap guide 74 and to bring the halves 20a, 20b together directly under the outlet 26 of the conduit 16 as the endcap 20 to block or cover the outlet 26.

The transporter 10 may further include an adjustable endcap mounting frame 88 that adjustably mounts the endcap carrier 70 to the conduit carrier 68. The mounting frame 88 may include opposed adapter plates 90 coupled to opposite sides of the outer sleeve 76 of the conduit carrier 68. The conduit carrier 68 includes opposed mounting bosses 92 that may be oblong, may fit into corresponding oblong reliefs in inboard surfaces of the plates 90, and may be fastened to the plates 90 by fastener(s) (not shown) extending through the plates 90 and into threaded passages in the oblong bosses 92. The conduit carrier 68 may of course be coupled to the adapter plates 90 by dovetail integral engagement or other mechanical mounting arrangements, or via welding, or in any other suitable manner. Moreover, to facilitate transport of the transporter 10, the conduit carrier 68 may fastened to a mounting plate 170 via a mounting boss 92 between the opposed mounting bosses 92 that are fastened to the adapter plates 90 and fasteners, with the mounting plate 170 also being coupled to a robot end effector or other driver capable of moving the transporter 10. The mounting frame 88 may also include endcap carrier extensions 94—one on each side of the transport cup 14-having lower ends coupled to the endcap actuator 72 on one side and to the endcap guide 74 via an adapter block 96 on the other side, and corresponding carrier extensions 98 coupled to and extending outward from the adapter plates 90.

The illustrated endcap carrier extension 94 shown coupled to the endcap guide 74 includes a plate 100 carrying the endcap guide adapter block 96 at a lower end via cap screws fastened through the plate 100 and into the block 96, and a guide block 102 fastened to an upper end of the plate 100 via cap screws extending through the plate 100 and into the guide block 102. The conduit carrier extension 98 may be fastened to the adapter plate 90 by cap screws or in any other suitable manner and may be fastened to the endcap carrier extension 94 by, for example, one or more fasteners 104 that extend through slots in sidewalls 106 of the conduit carrier extension 98 and into one or more corresponding threaded holes in the guide block 102 of the endcap carrier extension 94. One or more set screws 108 may additionally extend through an end wall 110 of the conduit carrier extension 98 and into corresponding threaded passages in the guide block 102 of the endcap carrier extension 94. In this way, the fasteners 104 can be loosened, the set screw(s) 108 turned to move the rest of the endcap carrier extension 94 to a desired position, and the fasteners 104 tightened to lock the endcap carrier extension 94 in the desired position relative to the conduit carrier extension 98 to adjust, if needed, the positioning of the endcap 20 relative to the conduit 16. The other endcap carrier extension 94 coupled to the endcap actuator 72 may be constructed in the same way albeit with the plate 100 being fastened directly to the endcap actuator 72 via cap screws.

The transporter 10 can be adapted for use with any suitable electrical, hydraulic, and/or pneumatic fittings, lines, adapters, valves, and the like, and can be coupled to any suitable source of electrical, hydraulic, and/or pneumatic power, to power the endcap actuator 72, supply fluid into the conduit 16 of the transport cup 14 through the fluid supply passage(s) 56, 58 of the endcap 20, and to supply cooling gas into the cooling chamber 50 of the conduit carrier 68. Likewise, any suitable controllers and controls can be employed to control the operation of the transporter 10. Moreover, the configurations of, and various subcomponents for the transporter 10, the transport cup 14, and/or the conduit 16 can vary depending on the desired implementation, and need not take the exact form illustrated herein. Rather, the embodiment illustrated in FIGS. 1-4 is meant to provide an example configuration that is particularly useful with the glass transport material 18 described below. Additional structural details and corresponding descriptions of the transporter 10 shown here in FIGS. 1-4, as well as variations thereof, are disclosed in a patent application designated by Attorney Docket. No. 19648, which is assigned to the assignee of this application and is hereby incorporated by reference in its entirety.

As discussed above, the glass transport material 18 from which the conduit 16 is constructed supports the diffusive flow of the cooling gas from the cooling chamber 50, through the intrinsic microstructure of the glass transport material 18 of the conduit 16, and into the passage 28. The microstructure 42 of the glass transport material 18 has a surface roughness 112, particularly along the inner surface 38 of the conduit 16, that presents a distribution of contact points 114. The permeability of the glass transport material 18 has a direct relationship to the ability of the material to achieve diffusive flow of the cooling gas through the conduit 16 at a rate sufficient to radially inwardly displace the molten glass charge G away from the inner surface 38 of the conduit 16 to establish the thermal break, which also helps to minimize friction between the glass charge G and the inner surface 38. The thermal break established between the molten glass charge G and the inner surface 38 of the conduit 16 helps thermally insulate the glass charge G and, thus, limits the transfer of heat out of the glass charge G in all directions over the period of time the glass charge G is contained within the conduit 16.

The glass transport material 18 also preferably has a relatively high thermal conductivity to inhibit the formation of localized hot spots on the inner surface 38 of the conduit 16. To minimize thermal transfer between the molten glass charge G and the inner surface 38 of the conduit 16, and thus help preserve the heat content and thermal homogeneity of the charge G, conventional wisdom would suggest that the glass transport material 18 should have as low of a thermal conductivity as possible to impede heat flow into the conduit 16. However, unexpectedly and to the contrary, a high thermal conductivity of the glass transport material 18 is believed to foster a more uniform thermal distribution in the molten glass charge G. Indeed, when the molten glass charge G is initially received within the conduit 16—at which point the glass charge G is most likely to make contact with the inner surface 38 of the conduit 16 via the contact points 114 of the surface 38—the ability of the glass transport material 18 to quickly conduct heat away from the inner surface 38 limits any momentary localized temperature increase that may occur along the inner surface 38 of the conduit 16. This reduction in the rate of surface temperature increase is understood to keep the glass transport material 18 from becoming too hot in localized areas and allowing glass to penetrate the surface porosity of the inner surface 38 of the conduit 16, possibly leading to sticking, which allows more heat transfer from the glass over the transport time resulting in the delivery of a colder charge.

A schematic representation of the molten glass charge G being displaced radially inwardly around its entire circumference within the conduit 16 by the permeable flow of cooling gas from the cooling chamber 50 is illustrated in FIGS. 3-4. In FIG. 3, the molten glass charge G is depicted at the moment it first enters the holding cavity 22 through the inlet 24 of the conduit 16. As shown, the molten glass charge G may initially make contact with the inner surface 38 through the contact points 114 of the surface 38, and those interfacial contact locations, if present, may allow heat to flow radially out of the charge G. While the molten glass charge G is entering the holding cavity 22, cooling gas diffusing permeably through the conduit 16 from the cooling chamber 50 exerts a pushing force on the glass gob G, as depicted in FIG. 4, to create the thermal break in the form of a gas barrier 40 between the glass transport material 18 of the conduit 16 and the glass charge G. The gas barrier 40 typically measures between 20 µm and 200 µm or more narrowly between 30 µm to 100 µm. The formation of the thermal break minimizes heat transfer between the conduit 16 and the molten glass charge G, and the thermal conductivity of the glass removes any induced thermal inhomogeneity within the glass charge G very quickly once the thermal break is formed.

The glass transport material 18 is preferably non-metal-based, such as a carbon-based material and, more preferably, a graphite-based material. As used herein, “-based” refers to materials that are greater than or equal to 50 wt% of the designated material. For example, a graphite-based material may be pure graphite (100 wt%) or a mixture having graphite as the main constituent (50 wt% or greater) along with other materials. A graphite-based material is a particularly good candidate for the glass transport material 18 because graphite can achieve various levels of permeability and thermal conductivity depending on various factors including how the graphite is formed and processed. Another quality of graphite-based materials that may be useful in constructing the conduit 16 is that graphite-based materials are self-lubricating. When the glass transport material 18 is self-lubricating, the molten glass charge G moves with less frictional resistance against the inner surface 38 of the conduit 16 when being received into the holding cavity 22. By reducing friction along the inner surface 38 of the conduit 16, the molten glass charge G is less likely to stick to the inner surface 38 and/or damage the contact points 114 of the inner surface 38. When the glass transport material 18 is formed of a graphite-based material, the target operating temperature of the glass transport material 18 may, in one example, lie between 100° C. and 400° C., and more preferably between 350° C. and 400° C., depending on thermal conductivity, as graphite-based materials may tend to oxidize undesirably as temperatures increase significantly beyond 400° C. Another self-lubricating, non-metal material that may be used as the glass transport material 18 is boron nitride-based (BN-based) materials and, more particularly, hexagonal boron nitride.

In one specific embodiment, the glass transport material 18 is composed of an extruded graphite. Extruded graphite can possess a relatively high permeability, including within the ranges specified above, and may also be more thermally conductive than other types of graphite, such as isostatically molded graphite, although isostatically molded graphite may certainly be used as the glass transport material 18 along with other types of graphite including other forms of cold molded graphite and vibratory molded graphite. As shown in general schematic fashion in FIGS. 3-4, grains or particles 118 (only a few are labeled for clarity purposes) of an extruded graphite glass transport material 18 have an extrusion axis A_{E} that is generally parallel to the conduit passage axis Ac. The extrusion axis A_{E} is measured with respect to the longest dimension of the respective particle 118. In this embodiment, the entirety of the conduit 16—that is, the entire sidewall 34 between the inlet and outlet end surfaces 30, 32—from the inlet 24 to the outlet 26 is composed of extruded graphite, and the conduit 16 is formed by machining the passage 28 with the desired microstructure 42 into a solid extruded graphite body having the general dimensions of the conduit 16. Constructing the conduit 16 from extruded graphite may also provide some control over the porosity of the inner surface 38 of the conduit 16, which may help establish the desired surface roughness 112 and permeability.

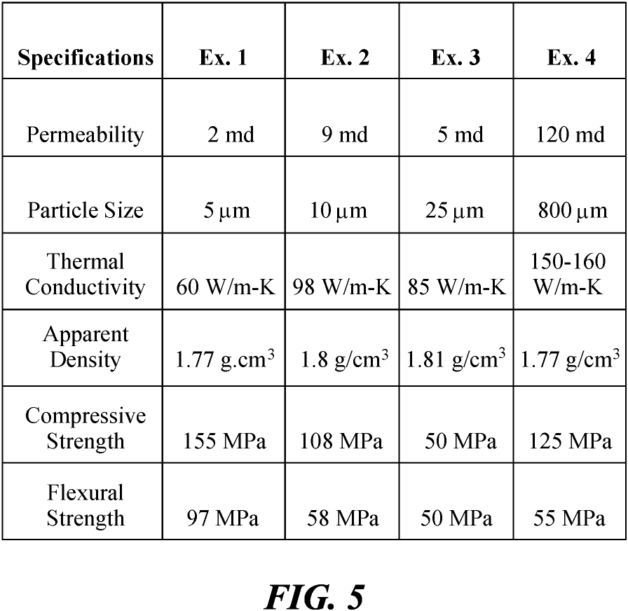

FIG. 5 is a chart illustrating several material properties including permeability and thermal conductivity of a several graphites that were identified as possible candidates for the glass transport material 18. Of these material candidates, Example 4 performed the best in terms of limiting heat loss from the molten glass and inhibiting glass sticking. Example 4 in particular has a permeability that is at least an order of magnitude larger than the other examples. The graphite designated as Example 4 is an extruded graphite identified as DT-585 and is available from DuraTemp Corporation (Holland, Ohio). While the Example 4 graphite performed the best of the four graphites, each graphite material listed in FIG. 5 could nonetheless be used as the glass transport material 18 for constructing the conduit 16. The graphite designated as Example 1 is an isostatically molded graphite identified as GLASSMATE-LT and is available from Entegris, Inc. (Billerica, Maryland). The graphites identified as Example 2 and 3 are isostatically molded graphites identified as GLASSMATE-SR available from Entegris, Inc. (Billerica, Maryland) and GR001-CC available from Graphtek LLC (Northbrook, Illinois), respectively.

The transporter 10 and the transport cup 14 described above can be used to receive and transport a charge of molten glass G for subsequent glass forming operations. For example, one method of transporting the molten glass charge G with the transport guide 16 as described above includes receiving the molten glass charge G in the molten glass transport guide 12. The method further includes displacing the molten glass charge G radially inwardly away from the inner surface 38 of the glass transport guide 12 to create a thermal break between the molten glass charge G and the glass transport material 18. In a more specific implementation, the molten glass transport guide 12 is the conduit 16 defining the inlet 24 and the outlet 26, as described above, and the conduit 16 is comprised of the glass transport material 18 described herein. Additionally, the method may include closing the conduit 16 with the endcap 20 prior to receiving the molten glass charge G in the conduit 16, and displacing the molten glass charge G away from the endcap 20 so that, in conjunction with the thermal break that circumferentially surrounds the glass charge G, the glass charge G is levitated away from the endcap 20 by the fluid cushion and is circumferentially separated from the inner surface 38 of the conduit 16. The molten glass charge G is thus floating within the holding cavity 22 of the conduit 16 and is not in direct contact with the conduit 16 or the endcap 20. Apart from transporting the molten glass charge G, there may be other reasons to float the glass charge G within the holding cavity 22 of the conduit 16 of the transport cup 14. In these instances, the transport cup 14 may remain stationary.

Another method of transporting a molten glass charge G includes receiving the molten glass charge G in the conduit 16. The conduit 16 is composed of the glass transport material 18 having a permeability ranging from 1 md to 250 md, or from 10 md to 150 md or from 50 md to 135 md, and a thermal conductivity that is greater than or equal to 40 W/m-°K. The method further includes displacing the molten glass charge G radially inwardly away from the inner surface 38 of the conduit 16 around the entire circumference of the glass charge G. In a more specific implementation, the method may also include creating a thermal break in the form of a gas barrier 40 between the molten glass charge G and the inner surface 38 of the conduit 16 that separates the glass charge G from the inner surface 38. Additionally, the method may include closing the conduit 16 with the endcap 20 prior to receiving the molten glass charge G in the conduit 16, and displacing the molten glass charge G away from the endcap 20 so that, in conjunction with the gas barrier 40 that circumferentially surrounds the glass charge G, the glass charge G is levitated away from the endcap 20 by the fluid cushion and is circumferentially separated from the inner surface 38 of the conduit 16 by the gas barrier 40. The molten glass charge G is thus floating within the holding cavity 22 of the conduit 16 and is not in direct contact with the conduit 16 or the endcap 20.

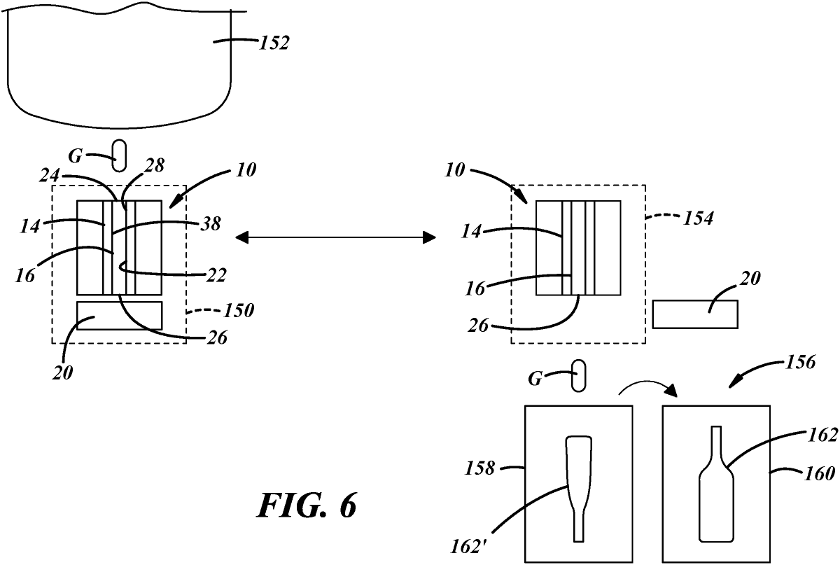

Referring now to FIG. 6, a schematic illustration of a method for transporting a charge of molten glass from one location (e.g., a loading location) to another location (e.g., an unloading location) is shown. To begin, the transporter 10 is positioned at a loading station 150 beneath, for example, a glass feeder 152 that is configured to deliver the charge of molten glass G. At the loading station, the endcap 20 is in the closed position where it covers or blocks the outlet 26 of the conduit 16 to axially close the passage 28 of the conduit 16 and create the holding cavity 22. The endcap 20 may be moved into the closed position at the loading station 150 or prior to arriving at the loading station 150. When the transporter 10 is at the loading station 150, the glass feeder 152 provides the molten glass charge G and the charge G falls freely into the holding cavity 22 through the inlet 24 of the conduit 16. Fluid is supplied into the holding cavity 22 through the endcap 20 to help receive the molten glass charge G into the conduit 16 and a thermal break is formed between the glass charge G and the inner surface 38 of the conduit 16 as described above. More specifically, to form the thermal break, the cooling gas supplied to the cooling chamber 50 of the transport cup 14 flows diffusively through the conduit 16 and into the holding cavity 22 at a permeable flow rate, which is controlled according to the loading phase of the cooling gas permeable flow cycle. The endcap 20 is shown here as a block that moves laterally between the closed and open positions. Such a depiction is schematic in nature and is meant to represent various possible movements including a swinging endcap and the opening and closing of the endcap halves 20a, 20b described above.

After the molten glass charge G is loaded into the transport cup 14, the transporter 10 is moved to an unloading station 154 where the transporter 10 is positioned above a glass container forming machine 156, which, here, includes a blank mold 158 and a blow mold 160, although other types of forming machines are possible. The permeable flow rate of the cooling gas through the conduit 16 and into the holding cavity 22 is controlled during movement of the transporter 10 according to the transport phase of the cooling gas permeable flow cycle. And, here, the transport cup 14 is not inverted during movement of the transporter 10 from the loading station 150 to the unloading station 154. When the transporter 10 is at the unloading station 154, the permeable flow rate of the cooling gas through the conduit 16 and into the holding cavity 22 is controlled according to the discharge phase of the cooling gas permeable flow cycle, and the endcap 20 is moved to its open position in which the holding cavity 22 is no longer established and the passage 28 is axially unobstructed at the outlet 26. The opening of the conduit 16 discharges the molten glass charge G through the outlet 26 of the conduit 16 by allowing the glass charge G to fall freely out of the conduit 16. The falling molten glass charge G is received in the blank mold 158 below. The molten glass charge G is then formed into a glass container 162 after being progressed through the blank mold 158 and the blow mold 160. Specifically, the molten glass charge G is formed into a parison 162′, or a partially formed container, in the blank mold 158, and the parison 162′ is then transferred into the blow mold 160. In the blow mold 160, the parison 162′ is formed into the finished glass container 162.

The positioning of the transporter 10 at the loading station 150 and the unloading station 154, and the movement of the transporter 10 between the stations 150, 154, may be accomplished in a variety of ways. For example, the transporter 10 may be conveyed linearly back-and-forth between the loading and unloading stations 150, 154 along a rail or a gantry by a linear drive motor, and the timing of the movements of the transporter 10 may be coordinated with the timing of the glass feeder 152 and the glass forming machine 156 by a control strategy using controls hardware and related software. As another example, an automated and programmable robot capable of movement in three or more axes may be used to position the transporter 10 and move the transporter 10 back-and-forth between the loading and unloading stations 150, 154. Other options are also available and, of course, multiple transporters 10 can be used together, and even be included on the same transport platform, to help ensure the continuous delivery of molten glass charges G from the glass feeder 152 to the blank mold 158 of one forming machine 156 or even multiple forming machines 156.

The subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. A molten glass transport cup, comprising:
a conduit defining an inlet, an outlet, and a passage between the inlet and the outlet, wherein the conduit is comprised of a glass transport material having a permeability between 1 md and 250 md and a thermal conductivity that is greater than or equal to 40 W/m-°K over the temperature range of 300° C.-400° C.

2. The molten glass transport cup set forth in claim 1, wherein the glass transport material has a permeability between 10 md to 150 md and a thermal conductivity between 100 W/m-°K and 200 W/m-°K over the temperature range of 300° C.-400° C.

3. The molten glass transport cup set forth in claim 1, wherein the glass transport material is a non-metal-based material.

4. The molten glass transport cup set forth in claim 1, wherein the glass transport material is a graphite-based material.

5. The molten glass transport cup set forth in claim 4, wherein the conduit is comprised entirely of graphite.

6. The molten glass transport guide set forth in claim 4, wherein the graphite-based material is extruded graphite.

7. The molten glass transport cup set forth in claim 1, further comprising:
a conduit carrier that holds the conduit, the conduit carrier including an outer sleeve that surrounds and is radially spaced from the conduit so as to establish a cooling chamber between the conduit and the outer sleeve; and
an endcap moveable to selectively cover and uncover the outlet of the conduit.

8. The molten glass transport cup set forth in claim 7, wherein one or more fluid supply passages are defined in the endcap.

9. A molten glass transport cup, comprising:
a conduit defining an inlet, an outlet, and a passage between the inlet and the outlet, wherein the conduit is comprised of a glass transport material and exhibits a permeable air flow rate of at least 100 g/s/m² at a pressure differential across the glass transport material of 30 psig or less, the glass transport material further having a thermal conductivity that is greater than or equal to 40 W/m-°K over the temperature range of 300° C.-400° C.

10. The molten glass transport cup set forth in claim 9, wherein the glass transport material has a permeability between 1 md and 250 md.

11. The molten glass transport cup set forth in claim 10, wherein the glass transport material has a permeability between 10 md and 150 md and a thermal conductivity between 100 W/m-°K and 200 W/m-°K over the temperature range of 300° C.-400° C.

12. The molten glass transport cup set forth in claim 9, wherein the glass transport material is a non-metal-based material.

13. The molten glass transport cup set forth in claim 9, wherein the glass transport material is a graphite-based material.

14. The molten glass transport cup set forth in claim 13, wherein the conduit is comprised entirely of graphite.

15. The molten glass transport guide set forth in claim 13, wherein the graphite-based material is extruded graphite.

16. The molten glass transport cup set forth in claim 9, further comprising:
a conduit carrier that holds the conduit, the conduit carrier including an outer sleeve that surrounds and is radially spaced from the conduit so as to establish a cooling chamber between the conduit and the outer sleeve; and
an endcap moveable to selectively cover and uncover the outlet of the conduit.

17. The molten glass transport cup set forth in claim 16, wherein one or more fluid supply passages are defined in the endcap.

18. A method of handling a molten glass charge, comprising:
receiving a molten glass charge in a holding cavity of a molten glass transport cup, the holding cavity being provided by a conduit, which defines a passage extending between an inlet and an outlet of the conduit, and an endcap moveable to cover and uncover the outlet of the conduit; and
suppling a cooling gas to an outer surface of the conduit such that the cooling gas diffuses permeably through the conduit and displaces the molten glass charge radially inwardly away from an inner surface of the conduit to create a thermal break between the molten glass charge and the conduit.

19. The method set forth in claim 18, wherein the conduit is comprised of a glass transport material having a permeability between 1 md and 250 md and a thermal conductivity that is greater than or equal to 40 W/m-°K over the temperature range of 300° C.-400° C.

20. The method set forth in claim 18, wherein the conduit exhibits a permeable air flow rate of at least 100 g/s/m² at a pressure differential across the glass transport material of 30 psig or less, and wherein the glass transport material further has a thermal conductivity that is greater than or equal to 40 W/m-°K over the temperature range of 300° C.-400° C.

21. The method set forth in claim 18, wherein the glass transport material is a graphite-based material.

22. The method set forth in claim 18, wherein the thermal break is in the form of a gas barrier.

23. The method set forth in claim 18, further comprising:
supplying a fluid into the holding cavity through the endcap to displace the molten glass charge away from the endcap.

24. A method of transporting a molten glass charge, comprising:
providing a transporter that includes a transport cup having a conduit, the conduit having an inner surface that defines a passage extending from an inlet of the conduit to an outlet of the conduit, and wherein the conduit exhibits a permeable air flow rate of at least 100 g/s/m² at a pressure differential across the conduit of 30 psig or less;
closing the conduit by positioning an endcap below the outlet of the conduit to cover and block the outlet and to thereby provide a holding cavity;
receiving a molten glass charge in the holding cavity through the inlet of the conduit at a loading station;
suppling a cooling gas to an outer surface of the conduit such that the cooling gas diffuses permeably through the conduit and displaces the molten glass charge radially inwardly away from the inner surface of the conduit to create a thermal break between the molten glass charge and the inner surface of the conduit;
transporting the transporter from the loading station to an unloading station; and
opening the conduit by moving the endcap away from the outlet of the conduit such that the molten glass charge is discharged from the outlet of the conduit.

25. The method set forth in claim 24, wherein the conduit is comprised of a glass transport material having a permeability between 1 md and 250 md and a thermal conductivity that is greater than or equal to 40 W/m-°K over the temperature range of 300° C.-400° C.

26. The method set forth in claim 24, wherein the cooling gas supplied to the outer surface of the conduit is air.

27. The method set forth in claim 24, wherein supplying the cooling gas comprises supplying the cooling gas to a cooling chamber that surrounds the conduit, and wherein a pressure of the cooling gas in the cooling chamber supports permeable flow of the cooling gas through the conduit.

28. The method set forth in claim 27, further comprising:
controlling permeable flow of the cooling gas through the conduit by controlling a pressure of the cooling gas in the cooling chamber.

29. The method set forth in claim 24, further comprising:
supplying a fluid into the holding cavity through the endcap to displace the molten glass charge away from the endcap.
